(19) United States
(12) Patent Application Publication
(10) Pub. No.: US 2004/0037412 A1
(43) Pub. Date: Feb. 26, 2004

(54) Real-time data management for a network comprising a heterogeneous set of terminals, server and main terminal for such a system

(76) Inventor: Herve Le Corre, Eterville (FR)

Correspondence Address: YOUNG & THOMPSON, 745 SOUTH 23RD STREET 2ND FLOOR, ARLINGTON, VA, 22202

(21) Appl. No.: 10/451,596

(22) PCT Filed: Dec. 24, 2001
(86) PCT No.: PCT/FR01/04194

(30) Foreign Application Priority Data
Dec. 26, 2000 (FR) 00/17062

(51) Int. Cl. H04M 7/00

(52) U.S. Cl. 379/220.01

(57) ABSTRACT

The invention concerns a data management system, for a local data transmission network (10) comprising terminals (8, 12, 14, 16, 18) with different data processing capabilities, including: first means (38) for determining the local network (10) terminal composition and their data processing capability; means (24) for analysing data transmitted to said local network; second means (26) for determining terminal(s) most suited for processing said data, based on the data processing capability of each of them; and means (28) for routing said data to the terminal(s) most suited as previously determined.

The present invention relates to a data management system, a service and a main terminal for such a system.

More precisely, the invention relates to a data management system for a local data transmission network comprising terminals having different data processing capacities.

A data management system of this type generally applies to data circulating between the terminals of the local network, but also to data received by the local network and destined for at least one terminal of this network and to data transmitted by at least one of the terminals of the network destined for example for a server or for an external network.

In particular, when a local network terminal transmits a request for data to a server which includes a multimedia data search engine in its databases which are accessible by the Internet, it receives from the server in return data corresponding to its request and for example taking the form of a multiplicity of data files of different formats and sizes.

During these operations the data management system of the local network undertakes the transmission of the request for data destined for the server and the transmission of the files returned to the terminal.

When this system is applied to a local network comprising different terminals, certain of which have limited data processing capacity whilst being adapted to transmit requests for data, particularly mobile terminals, these are not necessarily capable of processing the files which are returned in response to a request which they have transmitted.

It will be noted that processing of the files is understood to mean in particular the presentation to a user of the data which they contain.

The invention seeks to remedy these drawbacks of a conventional data management system of this type by creating a data management system capable of managing the data transmitted or received by the local network, taking account at best of the different processing capacities of the terminals of this network.

The invention therefore relates to a data management system for a local data transmission network comprising terminals having different data processing capacities, characterised in that it comprises:

first means for determination of the composition of the local network in terms of terminals and the data processing capacity of the terminals;

means for analysis of the transmitted data destined for this local network;

second means for determination of the most appropriate terminal or terminals for the processing of these data as a function of the data processing capacity of each of them;

means for routing of these data to the most appropriate terminal or terminals as determined previously.

Thus the data management system according to the invention enables, after analysis of the transmitted data destined for the local network, these data to be directed to the terminal or terminals most appropriate to the processing thereof, by virtue of the knowledge which it has of the composition of the local network in terms of terminals and the respective data processing capacity of the terminals.

The data management system according to the invention may also comprise one or more the following characteristics:

the transmitted data destined for the local network comprise several data portions of specific sizes and formats for each of them, and the second means for determination are means for determination, for each of these data portions, of the most appropriate terminal for the processing of this data portion as a function of the data processing capacity of each of the terminals;

the means for analysis of the transmitted data destined for the local network are means for analysis of formats and of sizes associated with these data;

the terminals are of different kinds;

the local data transmission network comprises a predetermined main terminal connected to an external data transmission network;

it comprises means for transmission of data originating from some of the terminals of the local network to storage means which are accessible by the external network;

the first means for determination are associated with means for automatic constitution of the local network comprising means for detection of terminals within a predetermined vicinity of the main terminal, and means for connection of these terminals and of the main terminal to one another;

the means for automatic constitution of the local network comprise means for activation of the first means for determination, from the time of the appearance of a change in the composition of this local network;

the main terminal is a mobile terminal;

the main terminal comprises means for automatic constitution of the local network and means for transmission of the composition of the local network in terms of terminals to the second means for determination of the most appropriate terminal or terminals; and

it further comprises a server, connected to the external network, comprising means for analysis, the second means for determination of the most appropriate terminal or terminals, the means for routing and means for data searching on the Web as a function of a request transmitted by the main terminal.

The invention also relates to:

a server for a data management system as described previously; and

a main terminal for a data management system as described previously.

The invention will be better understood on reading the following description which is given solely by way of example and with reference to the accompanying drawings, in which:

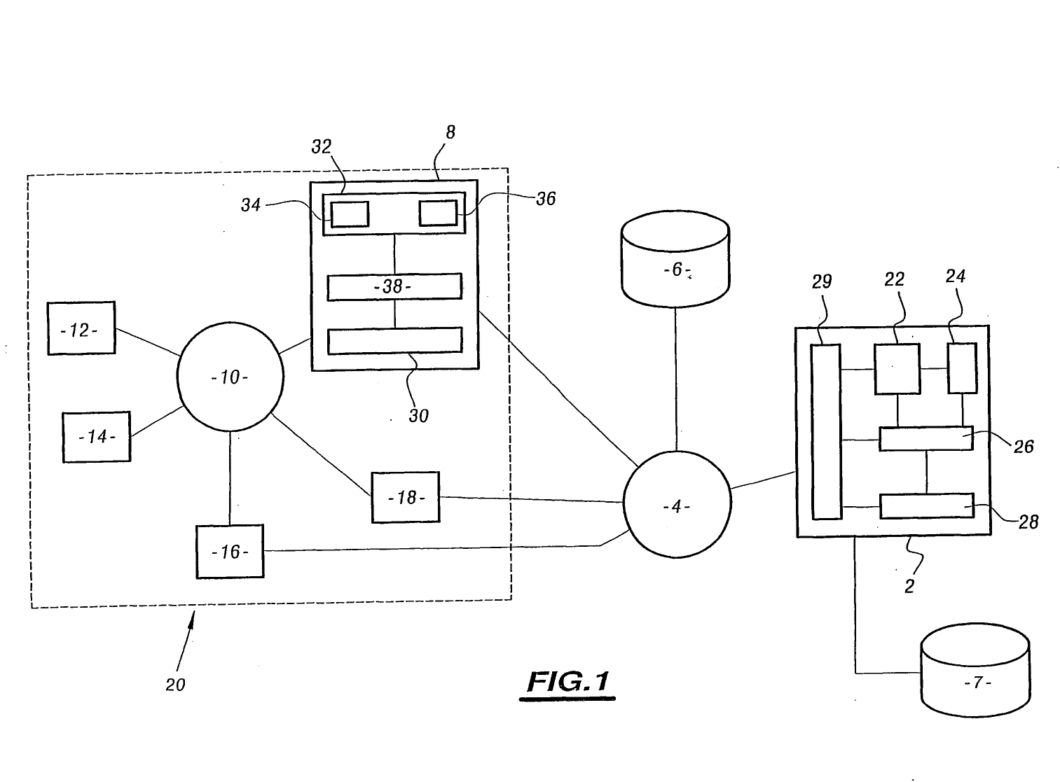

FIG. 1 is a schematic view of the general structure of a data management system according to a particular embodiment of the invention;

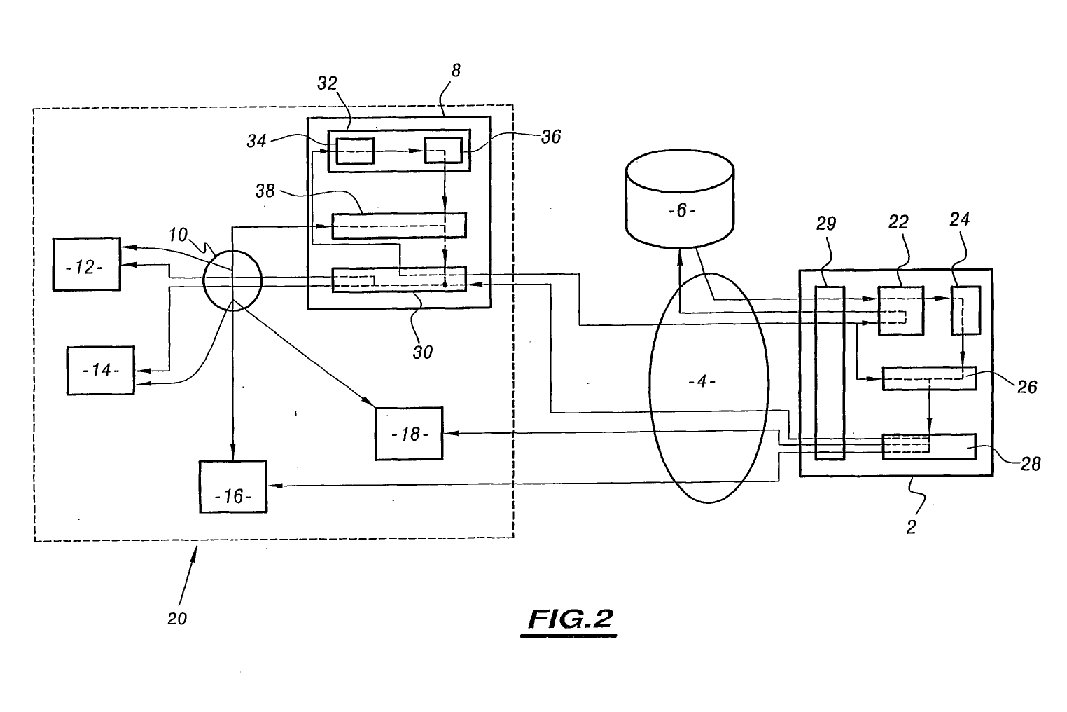

FIG. 2 is a schematic view showing the exchanges of data between the elements which constitute the data management system shown in FIG. 1, at the time of processing of a request for data transmitted by a terminal of the system;

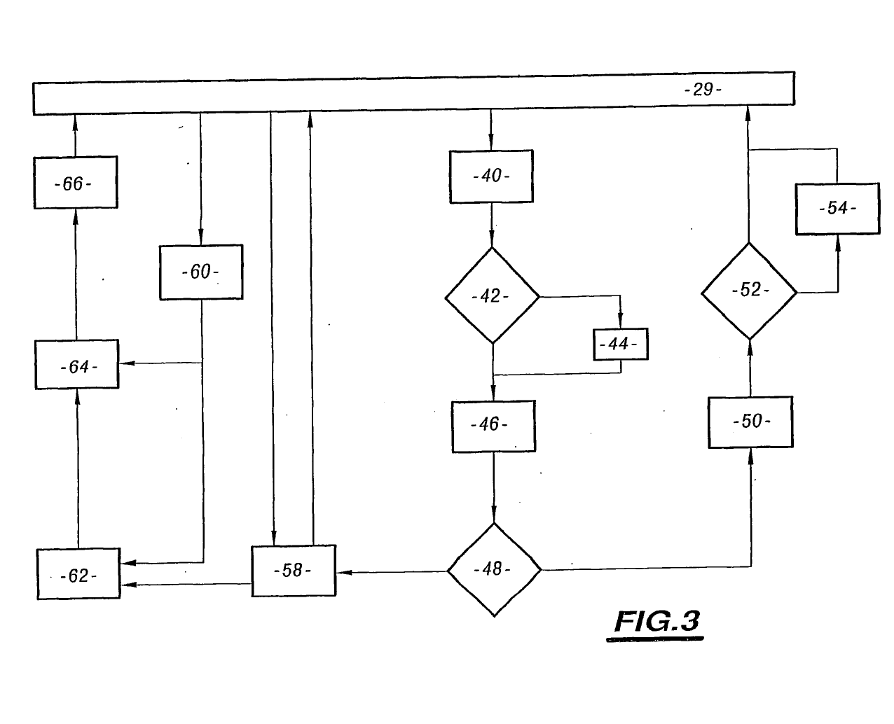

FIG. 3 shows, in the form of a flow chart, a method of management of a request for data by a server, employed in a data management system according to the invention; and

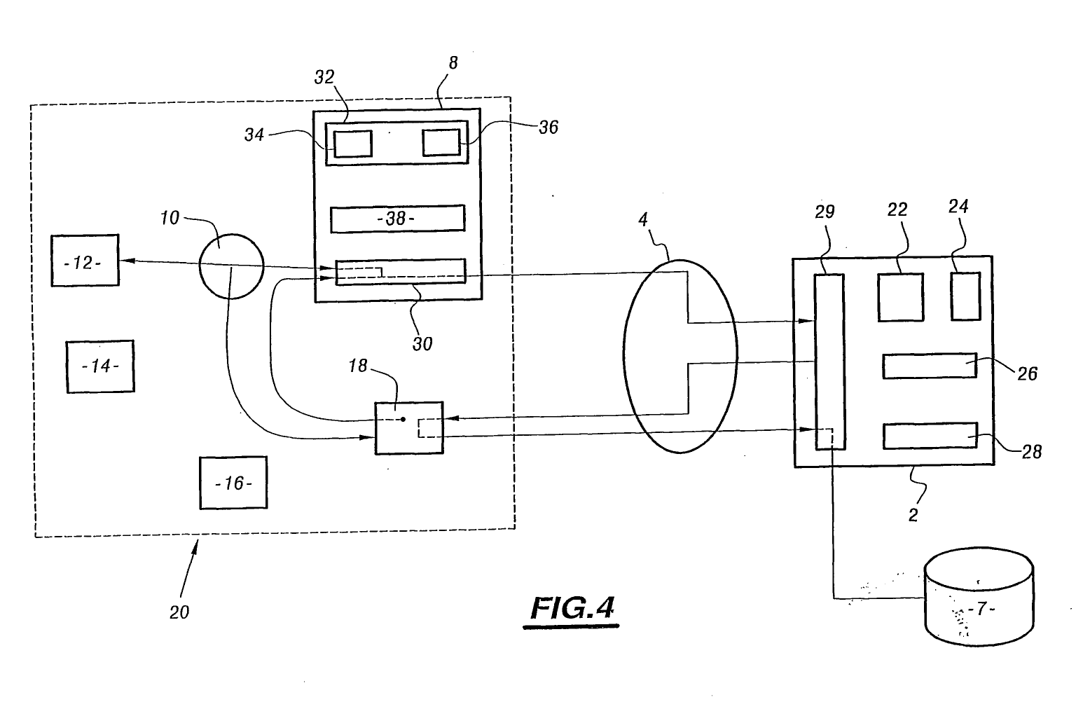

FIG. 4 is a schematic view showing the exchanges of data between the elements which constitute the data management system shown in FIG. 1, during the transmission of data transmitted by some of the terminals of the system.

The data management system shown in FIG. 1 has a server 2 connected to an external data transmission network 4.

In this example the external network 4 is, in a conventional manner, an assembly of interconnected heterogeneous networks, including inter alia the Internet, a switched telephone network and a network of the UMTS type. The connection of the server 2 to the network 4 is established in a conventional manner by means of a modem (not shown) which is itself connected to a link for access to the network 4.

Thus the server 2 has access to data stored in storage means 6, constituted here by the World Wide Web, usually called the Web.

The server 2 is also connected locally to storage means 7, comprising for example a database of the conventional type.

The server 2 is also accessible by a mobile terminal, likewise connected to the network 4. In this example the mobile terminal 8 is a third-generation mobile telephone supporting the conventional UMTS communication standard which enables it to exchange data with the server 2.

This mobile telephone 8 is also connected to other terminals situated in its vicinity by means of a local data transmission network 10. These other terminals are for example a microcomputer 12, loudspeakers 14, a fax machine 16 and a digital personal organiser 18. The local network 10 for its part is preferably a network for Hertzian transmission of communications.

These terminals 8, 12, 14, 16 and 18 are equipped with means for communication with each other via the local network 10, supporting the conventional Bluetooth technology. Thus they form an assembly 20 of terminals capable of exchanging data with each other by the Hertzian route, conventionally called the pico-net.

Amongst the pico-net terminals, apart from the mobile telephone 8, the fax machine 16 is connected to the data transmission network 4 by means of a conventional telephone line, and the personal organiser 18 is likewise connected to the data transmission network 4 by means of a wireless data transmission channel supporting the conventional WAP communication protocol.

The server 2 has an input/output interface 29 of the conventional type adapted for the exchange of data with the data transmission network 4, destined for or originating from one of the terminals 8, 12, 14, 16 and 18 and the Web 6.

This server 2 also has a search engine 22 connected to the input/output interface 29 by a data transmission bus of the conventional type. This search engine 22 may have any suitable conventional structure whatsoever, for example based on a computer, to receive data requests from the mobile telephone 8, to analyse these requests and to receive data originating from the Web 6 as a function of the said requests.

For example, the search engine 22 includes a voice synthesiser to transform data of the textual type into audio data, and a voice dictation system to transform audio data into data of the textual type.

The server 2 also has means 24 for analysis of the received data originating from the Web 6 in response to a request transmitted by the mobile telephone 8 and transmitted to the search engine 22.

The means for analysis 24 are adapted to process the data originating from the Web 6 in order to determine the size in bytes and the format of each of these data.

The means for analysis 24 may generally include for example computer systems programmed in order to carry out this function.

The server 2 also has means for adaptation 26 of the data originating from Web 6 to the structure of the pico-net 20. The means for adaptation 26 are connected to the input/output interface 9, to the search engine 22 and to the means for analysis 24 by a data transmission bus.

They are adapted for the determination of the terminal or terminals of the pico-net 20 most appropriate for the processing of the data originating from the Web 6.

They also have conventional means for conversion of format (not shown), in order to convert data originating from the Web 6 and analyses by the means for analysis 24. The functioning of these means will be detailed below.

Finally, the server 2 includes routing means 28 in order to direct each of the data originating from the Web 6 and responding to a request transmitted by the mobile telephone 8 to the terminal or terminals of the pico-net 20 determined by the means for adaptation 26 as being the most appropriate for processing these data.

In order to carry out this operation, the routing means are themselves also connected to the input/output interface 29 of the server 2.

The mobile telephone 8 for its part has an input/output interface 30 for the exchange of data with the server 2 via the data transmission network 4 and for the exchange of data with the other terminals 12, 14, 16 and 18 of the pico-net 20 via the local network 10.

The mobile telephone 8 also has means 32 for automatic constitution of the local network 10.

These means 32 for automatic constitution include in a conventional manner means 34 for detection of terminals within a predetermined vicinity of the mobile telephone 8, and means 36 for automatic connection of these terminals, that is to say in this example the microcomputer 12, the loudspeakers 14, the fax machine 16 and the digital personal organiser 18, to the mobile telephone 8. This latter then forms the main terminal of the pico-net 20 thus constituted. The means 34 for detection of terminals are adapted to supply to the connection means 36 all of the terminals situated in the vicinity of the mobile telephone 8 in response to a request from this latter. Finally, the mobile telephone 8 has means 38 for determination of the composition of the pico-net 20 in respect of terminals 8, 12, 14, 16 and 18 and of the respective data processing capacities of these terminals.

The means 32 for automatic constitution of the local network 10 and the means 38 for determination of the composition of the pico-net 20 in terms of terminals may generally include computer systems programmed to carry out these functions.

Such computer systems are already known in the prior art, so that they will not be described in detail.

A description will now be given with reference to FIG. 2 of the exchanges of data effected between the terminals of the pico-net 20 and the server 2 in the case of a data request transmitted by the mobile telephone 8.

A data request transmitted by the mobile telephone 8 is input into the latter by a user, for example manually or orally.

When this request is recorded by the interface 30 of the mobile telephone 8, this latter transmits a preliminary request for data concerning the constitution of the pico-net 20 to the detection means 34. In response, these latter transmit to the connection means 36 data concerning all of the terminals 12, 14, 16, 18 situated in the vicinity of the mobile telephone 8.

The connection means 36, after having established or verified the connection of these terminals to the mobile telephone 8, activate the determination means 38.

These latter then collect data concerning data processing capacity for each of the terminals 8, 12, 14, 16, 18 of the local network 10 and transmit these data to the interface 30 of the mobile telephone 8.

The mobile telephone 8 then transmits to the server 2 the data request recorded by the interface 30 and associated with the data concerning the composition of the local network 10 in terms of terminals and the data processing capacity of the terminals.

These data are transmitted by the input/output interface 29 of the server 2 on the one hand to the search engine 22 in relation to the data request and on the other hand to the adaptation means 26 in relation to the data concerning the composition of the local network 10 in terms of terminals and the data processing capacity of the terminals. The search engine 22 then interrogates the Web 6 as a function of the data request transmitted by the mobile telephone 8.

Data originating from the Web 6 are recovered by the search engine 22, then supplied to the analysis means 24.

These analysis means 24, after treatment of the data received in response to the data request, supply data relating to the format and the size of the each of these data to the adaptation means 26.

The adaptation means 26 then transmit to the routing means 28 the received data originating from the Web 6, associating each of them with instructions for routing to a terminal of the pico-net 20 selected as being the most appropriate for processing it.

As a function of these instructions, the routing means 28 transmit each item of data supplied in response to the data request transmitted by the mobile telephone 8 to the terminal of the pico-net 20 selected for processing this item of data.

The routing means 28 directly transmit each item of data to the terminal concerned, if this is the fax machine 16 or the personal organiser 18 or the mobile telephone 8, all three of which are connected to the network 4.

On the other hand, if the terminal selected for processing this item of data is the microcomputer 12 or the loudspeaker 14, which are not connected directly to the network 4, the routing means 28 transmit this item of data to the interface 30 of the mobile telephone 8, which serves to transmit this data to the terminal concerned via the local network 10.

A detailed description will now be given of the operation of the server 2 in the case of management of a data request, with reference to FIG. 3.

When the input/output interface 29 of the server 2 receives a data request originating from the mobile telephone 8, during a first step 40, it transmits it to the search engine 22.

In a following step 42, the search engine 22 determines the format of this request.

If it is a request input orally by the user of the mobile telephone 8, the system passes to a step 44 of transformation of this oral request into a textual request, followed by a step 46 of analysis of the request.

On the other hand, if the request has been input manually by the user in textual form, the system passes directly to step 46 of analysis of the request.

Then in a test step 48, the search engine 22 determines whether the request is sufficiently clear and precise.

If this is the case, the system passes to a step 58 of interrogation of the Web 6, if not it proceeds to a step 50 of demand for precision.

When this demand for precision is formulated, the system proceeds to a step 52 of determination of the mode most adapted to the demand for precision. If during this step the vocal mode is chosen by the search engine 22, the system proceeds to a step 54 of transformation of the demand for precision, initially textual, into a vocal demand for precision.

Following steps 52 and 54, the demand for precision is sent to the mobile telephone 8 and thus to the user.

The response to this demand for precision is then processed by the search engine 22 as the initial data request, at step 40.

In the step 58 of interrogation of the Web 6, the search engine 22 interrogates the Web 6 as a function of the data request and receives, originating from the Web 6, multimedia data corresponding to this request.

In this same step 58, the search engine 22 transmits the data received to the analysis means 24, which determine the format and the size of the data.

In a step 60, the input/output interface 29 of the server 2 transmits to the adaptation means 26 the data relating to the configuration of the pico-net 20.

Following steps 58 and 60, in a step 62 of conversion the adaptation means 26 convert some of the data originating from the Web 6 and received in step 58 as a function of the processing capacities of the different terminals 8, 12, 14, 16 and 18, as appropriate.

In fact, during this step the adaptation means 26 verify that, for each item of data received, its format and/or its size is/are adapted to the processing capacities of at least one of the terminals 8, 12, 14, 16 and 18. If this is not the case, they convert the format and/or the size of this item of data in accordance with a format and/or a size which can be processed by one of the said terminals.

Then in a step 64 of selection the adaptation means 26 select, for each item of data received from the Web 6 and converted if need be, the terminal of the pico-net 20 most adapted for processing it.

The selection is made, for example, in a conventional manner by means of cross-reference table including the processing capacities of each of the terminals of the pico-net 20, which is accessible and updated by the adaptation means 26 during step 60.

Finally, during a step 66 of transmission, the routing means 28 transmit each of the data originating from the Web 6 to each of the selected terminals of the pico-net 20, either directly or indirectly, as described previously.

A description will now be given with reference to FIG. 4 of the exchanges of data effected between the pico-net 20 and the server 2, in the case of transmission of data transmitted by some of the terminals 8, 12, 14, 16, 18 in the direction of the server 2.

A data transmission order is for example input manually by a user in the digital personal organiser 18. This transmission order contains the identification data for the data to be transmitted and the identification data for the terminal or terminals of the local network 10 transmitting these data.

For example, these data are data stored in the microcomputer 12 and in the digital personal organiser 18. In this case the transmission/reception means 30 of the mobile telephone 8 collect the data to be transmitted, by exchange of data with the microcomputer 12 and the digital personal organiser 18, via the local network 10.

The interface 30 of the mobile telephone 8 then transmits these collected and assembled data to the server 2 via the external network 4.

Upon reception of these data by the interface 29, the latter sends for example directly to the digital personal organiser 18 a form to be completed by the user, which enables him to classify these data according to certain predetermined criteria in the database 7.

The user completes this form by means of his digital personal organiser 18 and sends it back to the server 2.

Finally, the input/output interface 29 stores the data transmitted by the mobile telephone 8 in the database 7 according to the classification prescribed by the completed form.

Therefore it is clear that the data management system according to the invention makes it possible to improve the exchanges of data for a data transmission network such as a local network 10 of terminals forming a pico-net 20 by analysing these data and determining the terminal or terminals most appropriate for processing these data, as a function of the processing capacity of each of them.

It also makes it possible simultaneously to effect the transmission of data originating from a multiplicity of terminals of the local network 10 to the server 2 by means of one single terminal among the terminals of the local network 10.

Finally, it will be noted that the invention is not limited to the embodiment described.

Thus, as a variant, the server 2 is integrated into the mobile terminal 8 when this latter has sufficient processing capacity to include such a server.

1. Data management system for a local data transmission network (10) comprising terminals (8, 12, 14, 16, 18) having different data processing capacities, characterised in that at the level of the local network (10) it comprises first means (38) for determination of the composition of the local network (10) in terms of terminals and the data processing capacity of the terminals, connected by an external network (4) to:
means (24) for analysis of the data to be transmitted destined for the said local network (10);
second means (26) for determination of the most appropriate terminal or terminals for the processing of these data as a function of the data processing capacity of each of them, determined by the first means (38) for determination and data delivered by the means (24) for analysis of the data to be transmitted; and
means (28) for routing of these data enabling them to be transmitted directly to the most appropriate terminal or terminals as determined previously.

2. Data management system as claimed in claim 1, characterised in that the transmitted data destined for the local network (10) comprise several data portions of specific sizes and formats for each of them, and that the second means for determination (26) are means for determination, for each of these data portions, of the most appropriate terminal (8, 12, 14, 16, 18) for the processing of this data portion as a function of the data processing capacity of each of the terminals, the said routing means (28) being adapted to transmit each data portion directly to the most appropriate terminal as determined previously.

3. Data management system as claimed in claim 1, characterised in that the means (26) for analysis of the transmitted data destined for the local network (10) are means for analysis of formats and of sizes associated with these data.

4. Data management system as claimed in any one of claims 1 to 3, characterised in that the terminals (8, 12, 14, 16, 18) are of different kinds.

5. Data management system as claimed in any one of claims 1 to 4, characterised in that the local data transmission network (10) comprises a predetermined main terminal (8) connected to the said external data transmission network (4).

6. Data management system as claimed in claim 5, characterised in that it comprises means (30) for transmission of data originating from some of the terminals of the local network (10) to storage means (7) which are accessible by the external network (4).

7. Data management system as claimed in claim 5 or 6, characterised in that the first means for determination (38) are associated with means (32) for automatic constitution of the local network (10) comprising:
means (34) for detection of terminals (12, 14, 16, 18) within a predetermined vicinity of the main terminal (8); and
means (36) for connection of these terminals and of the main terminal to one another.

8. Data management system as claimed in claim 7, characterised in that the means (32) for automatic constitution of the local network (10) comprise means for activation of the first means for determination (34), from the time of the appearance of a change in the composition of this local network.

9. Data management system as claimed in any one of claims 5 to 8, characterised in that the main terminal (8) is a mobile terminal.

10. Data management system as claimed in any one of claims 7 to 9, characterised in that the main terminal (8) comprises means (32) for automatic constitution of the local network (10) and means for transmission of the composition of the local network (10) in terms of terminals to the second means (26) for determination of the most appropriate terminal or terminals.

11. Data management system as claimed in any one of claims 5 to 10, characterised in that it further comprises a server (2), connected to the external network (4), comprising means for analysis (24), the second means (26) for determination of the most appropriate terminal or terminals, the means for routing (28) and means (22) for data searching on the Web (6) as a function of a request transmitted by the main terminal (8).

12. Server for a data management system as claimed in claim 11, characterised in that it is connected to the external network (4), comprising means for analysis (24), the second means (26) for determination of the most appropriate terminal or terminals, the means for routing (28) and means (22) for data searching on the Web (6) as a function of a request transmitted by the main terminal (8).

13. Main terminal for a data management system as claimed in any one of claims 5 to 11, characterised in that it is connected to the external data transmission network (4) and that it comprises means (32) for automatic constitution of the local network (10) and means for transmission of the composition of the local network (10) in terms of terminals to the second means (26) for determination of the most appropriate terminal or terminals.
